(19) United States
(12) Patent Application Publication
(10) Pub. No.: US 2011/0134444 A1
(43) Pub. Date: Jun. 9, 2011

(54) IMAGE FORMING APPARATUS AND SCANNING METHOD THEREOF

(75) Inventor: Ho-keun LEE, Suwon-si (KR)

(73) Assignee: Samsung Electronics Co., Ltd., Suwon-si (KR)

(21) Appl. No.: 12/872,071

(22) Filed: Aug. 31, 2010

(30) Foreign Application Priority Data
Dec. 7, 2009 (KR) 2009-120511

(51) Int. Cl. H04N 1/04

(52) U.S. Cl. 358/1.5; 358/474

(57) ABSTRACT

A scanning method of an image forming apparatus including free-scanning a page to be scanned, setting a scan data generation area to generate scan data on the free-scanned image, if a subsequent page is main-scanned, detecting a relative position of the scan data generation area from a scanned area of the main-scanned page, adjusting the scan data generation area using the detected relative position, and generating scan data for the adjusted scan data generation area, and an image forming apparatus to perform the same. Therefore, a plurality of pages can be precisely scanned or copied with a specific size.

### CROSS-REFERENCE TO RELATED APPLICATIONS

This application claims priority under 35 U.S.C. §119 (a) from Korean Patent Application No. 10-2009-0120511, filed on Dec. 7, 2009, in the Korean Intellectual Property Office, the disclosure of which is incorporated herein by reference in its entirety.

### BACKGROUND

1. Field of the Invention

The present general inventive concept relates to an image forming apparatus and a scanning method thereof. More particularly, the present general inventive concept relates to an image forming apparatus capable of providing precise scanning for a plurality of pages, and a scanning method thereof.

2. Description of the Related Art

As electronic technology has been developing, printers, and peripherals such as printers and scanners as well as computers have propagated. In particular, in the printer industry, companies are scrambling to develop new technologies, so generally used dot printers and inkjet printers have been replaced with laser printers having remarkable advantages in printing quality, printing speed, and noise upon printing, recently. In a laser printer, toner is put on a photoconductor using a laser beam converted into an image signal, then is transferred from the photoconductor onto printing paper, and is finally fused on the printing paper using high heat and pressure.

In a conventional multi-page scanning method, when a book is scanned or copied, if an area to be initially designated to be scanned does not change for each page, scan data are generated to have the same size for each page. However, when a subsequent page of the book is placed on the scanner to be scanned, the subsequent page may be placed out of the initially designated area. In this case, a wrong area may be scanned with respect to the previous area, as illustrated in FIGS. 1A to 2C.

FIGS. 1A to 2C illustrate scanning results according to a conventional multi-page scanning method.

As illustrated in FIG. 1A, a user precisely sets a scanning area of a first page of a document to be scanned using a preview feature. However, FIG. 1B illustrates an area obtained when a second page is scanned using the area initially set in FIG. 1A, and FIG. 1C illustrates an area obtained when the third page is scanned also using the area initially set in FIG. 1A. FIGS. 2A to 2C illustrate scan data output corresponding to scan areas shown in FIGS. 1A to 1C.

As illustrated in FIGS. 2A to 2C, in the conventional multi-page scanning method, data are scanned to have the same size for each page, but these data are not precisely scanned for each respective page.

### SUMMARY

The present general inventive concept provides an image forming apparatus capable of providing precise scanning for a plurality of pages, and a scanning method thereof.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a scanning method of an image forming apparatus, the scanning method including free-scanning a page to be scanned, setting a scan data generation area to generate scan data on the free-scanned image, if a subsequent page is main-scanned, detecting a relative position of the scan data generation area from a scanned area of the main-scanned page, adjusting the scan data generation area using the detected relative position, and generating scan data for the adjusted scan data generation area.

The setting of the scan data generation area may include displaying the free-scanned image on a user interface (UI), and receiving settings of the scan data generation area according to a user's selection using the UI.

The detecting of the relative position may include storing a density pattern for an external area of the scan data generation area, sensing a position corresponding to the density pattern from among the scanned area of the main-scanned page, and determining the relative position of the scan data generation area based on the sensed position.

In the sensing of the position corresponding to the density pattern, it may be determined if the density pattern corresponds to the main-scanned area from one side of the main-scanned area in sequence.

The page to be scanned may be each page of a document for bookbinding, and if the scan data generation area is set on one of a left page and a right page of the document for bookbinding, in the sensing of the position corresponding to the density pattern, a shape of the density pattern may be mirrored for the other page and it may be determined if the main-scanned area of the other page corresponds to the mirrored density pattern from one side of the main-scanned area.

In the detecting of the relative position of the scan data generation area, a main-scanned image for the page to be scanned may be reduced and the relative position of the scan data generation area may be detected on the reduced image.

The foregoing and/or other features and utilities of the present general inventive concept may also be achieved by providing a scanning method of an image forming apparatus, the scanning method including setting a scan data generation area to generate scan data, if data are scanned, detecting an area corresponding to the scan data generation area based on change of a density pattern of the scanned data, adjusting the scan data generation area to become the detected area, and generating scan data for the adjusted scan data generation area on the scanned data.

The foregoing and/or other features and utilities of the present general inventive concept may also be achieved by providing a scanning method of an image forming apparatus, the scanning method including setting a scan data generation area to generate scan data, if a document is scanned, determining if an image of the scanned document gets out of the scan data generation area using change of a density pattern, if the image of the scanned document gets out of the scan data generation area, adjusting the scan data generation area to include the image of the scanned document, and generating scan data for the adjusted scan data generation area.

The foregoing and/or other features and utilities of the present general inventive concept may also be achieved by providing an image forming apparatus including an image reading unit to free-scan a page to be scanned, a detection unit to set a scan data generation area to generate scan data on the free-scanned image, and if the image reading unit main-scans a subsequent page, to detect a relative position of the scan data generation area from a scanned area of the main-scanned page, a control unit to adjust the scan data generation area using the detected relative position and generate scan data for the adjusted scan data generation area.

The image forming apparatus may further include a user interface (UI) unit to display the free-scanned image and receive settings of the scan data generation area according to a user's selection.

The image forming apparatus may further include a communication interface unit to transmit the free-scanned image to a host device and receive data regarding the scan data generation area set on the free-scanned image from the host device.

The image forming apparatus may further include a storage unit to store a density pattern for an external area of the scan data generation area, wherein the detection unit may sense a position corresponding to the density pattern from among the scanned area of the main-scanned page and determine the relative position of the scan data generation area based on the sensed position.

The detection unit may determine if the density pattern corresponds to the main-scanned area from one side of the main-scanned area in sequence.

The page to be scanned may be each page of a document for bookbinding, and if the scan data generation area is set on one of a left page and a right page of the document for bookbinding, the detection unit may mirror a shape of the density pattern for the other page and determine if the main-scanned area of the other page corresponds to the mirrored density pattern from one side of the main-scanned area.

The detection unit may reduce a main-scanned image for the page to be scanned and detect the relative position of the scan data generation area on the reduced image.

Accordingly, a plurality of pages (for example, a document for bookbinding) can be precisely scanned or copied with a specific size.

In addition, a plurality of pages can be scanned more rapidly than when the user sets a scan data generation area for each page.

The foregoing and/or other features and utilities of the present general inventive concept may also be achieved by providing a scanning method of an image forming apparatus, comprising: scanning a page; determining boundaries of data of the scanned page to create a data generation area; scanning a subsequent page and determining boundaries of the scanned subsequent page; adjusting the created data generation area by comparing the boundaries of the scanned subsequent page; and generating scan data for the adjusted data generation area.

The foregoing and/or other features and utilities of the present general inventive concept may also be achieved by providing an image forming apparatus, comprising: a detection unit to set a scan data generation area to generate scan data on a first scanned image, and to detect a relative position of a scan data generation area from a scanned area of a subsequent scanned page; and a control unit to adjust the scan data generation area using the detected relative position and generate scan data for the adjusted scan data generation area.

### BRIEF DESCRIPTION OF THE DRAWINGS

These and/or other features and utilities of the present general inventive will become apparent and more readily appreciated from the following description of the embodiments, taken in conjunction with the accompanying drawings of which

FIGS. 1A to 2C illustrate scanning results according to a conventional multi-page scanning method;

FIG. 3 is a schematic block diagram illustrating a configuration of an image forming apparatus according to an exemplary embodiment of the present general inventive concept;

FIG. 4 is a schematic block diagram illustrating a configuration of a printing control terminal apparatus according to an exemplary embodiment of the present general inventive concept;

FIGS. 5A and 5B illustrate a method for designating a scan area according to an exemplary embodiment of the present general inventive concept;

FIGS. 6A and 6B illustrate a method for detecting a relative position of a scan data generation area according to an exemplary embodiment of the present general inventive concept;

FIGS. 7A to 7C and FIGS. 8A to 8C illustrate scanning results obtained using a scanning method according to an exemplary embodiment of the present general inventive concept; and

FIG. 9 is a flow chart illustrating a scanning method of an image forming apparatus according to an exemplary embodiment of the present general inventive concept.

### DETAILED DESCRIPTION OF THE EMBODIMENTS

Reference will now be made in detail to the present embodiments of the present general inventive concept, examples of which are illustrated in the accompanying drawings, wherein like reference numerals refer to like elements throughout. The embodiments are described below in order to explain the present general inventive concept by referring to the figures

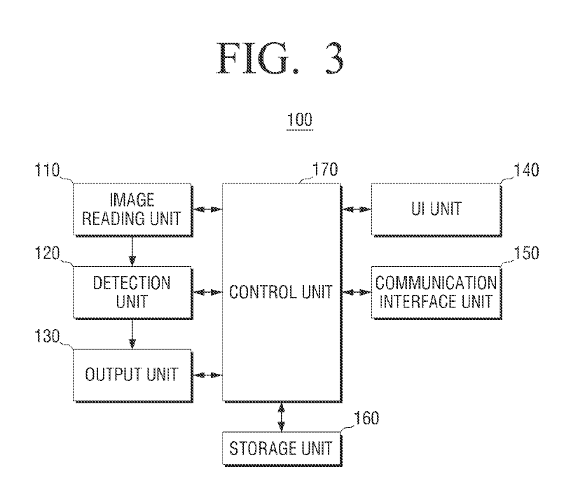

FIG. 3 is a schematic block diagram illustrating a configuration of an image forming apparatus according to an exemplary embodiment of the present general inventive concept.

As illustrated in FIG. 3, the image forming apparatus 100 may include an image reading unit 110, a detecting unit 120, an output unit 130, a user interface (UI) unit 140, a communication interface unit 150, a storage unit 160, and a control unit 170.

The image forming apparatus 100 can be connected to an external device so as to output data. The image forming apparatus 100 may be implemented as a printer, a scanner, a copier, a facsimile machine, and a multifunction peripheral having at least two functions among a printer, a scanner, a copier, and a facsimile machine.

The image reading unit 110 reads out a page of a document using an image sensor.

The image reading unit 110 performs free scanning to support preview of a scan area of a first page from among a plurality of pages, and performs main scanning to generate actual scan data for the remaining pages. For example, when a plurality of pages are copied or scanned, the image reading unit 110 performs scanning. The plurality of pages to be scanned by the image reading unit 110 may be a document for bookbinding. In some cases, the plurality of pages to be scanned by the image reading unit 110 may not be a document for bookbinding, but can be applied to scan a specific area of each of the plurality of pages.

The image reading unit 110 may be implemented as a scanning unit to perform scanning.

The image reading unit 110 performs scanning according to operation of the control unit 180. The image reading unit 110 may include an image sensor (not shown), a motor (not shown), a position sensor (not shown), and a scanning controller (not shown).

The image sensor (not shown) may include a Contact Image Sensor (CIS) (not shown) which senses an image so as to obtain an RGB pixel value, and may transmit an RGB pixel value of each position sensed using the CIS to the scanning controller (not shown).

The motor (not shown) moves the document in a scanning processing direction so that RGB pixel values of an image on the document can be sensed line by line.

The position sensor (not shown) senses the position of a document provided to the image forming apparatus 100 and transmits the sensed position to the scanning controller (not shown). The scanning controller (not shown) controls the image sensor (not shown), the motor (not shown), and the position sensor (not shown) to perform scanning according to a scanning command received from the control unit 180. That is, the scanning controller (not shown) generates image data corresponding to an image on a document by combining RGB pixel values sensed by the image sensor (not shown). Description of other scanning operations is omitted for brevity of the specification.

If a scan data generation area to generate scan data is set on a page free-scanned by the image reading unit 110, and if the image reading unit 110 performs main scanning of another page, the detection unit 120 detects a relative position of the scan data generation area, which was generated on the free-scanned image, for a scan area of the main-scanned page.

The control unit 170 adjusts a scan data generation area for the main-scanned page using the relative position detected by the detection unit 130, and generates scan data for the adjusted scan data generation area.

The output unit 130 outputs the scan data generated by the control unit 170 onto a recording medium.

That is, the output unit 130 prints image data on the recording medium. For example, in a laser image forming apparatus, an electrification unit electrifies the surface of an organic photoconductor (OPC) (not shown), and a laser scanner unit (LSU) (not shown) generates a latent image on the electrified area. If a developing unit (not shown) develops the latent image, toner is attached to the latent image and is transferred onto paper by the transfer unit (not shown). However, this is merely an example. The present general inventive concept may be applied to an inkjet image forming apparatus.

The UI unit 140 may include operation keys (not shown) to input a user command to control the image forming apparatus 100, and a display window (not shown), such as a liquid crystal display (LCD), to display the state of the image forming apparatus 100. Alternatively, the UI unit 140 may be implemented as a device capable of input and output at the same time, such as a touch pad.

The UI unit 140 displays diverse information provided by the image forming apparatus 100, and also displays the current status and the result of a job being performed by the image forming apparatus 100. The user identifies, manages and controls diverse printing jobs of the image forming apparatus 100.

In addition, the UI unit 140 receives a scanning command and transmits the scanning command to the control unit 180.

The communication interface unit 150 supports data communication with an external device (not shown) through a network. For example, the communication interface unit 150 may be implemented to support a Digital Living Network Alliance (DLNA) network, a local scheme, a local area network (LAN), or the Internet network.

The storage unit 160 may be implemented as a storage medium provided in the image forming apparatus 100 or an external storage medium, for example, a removable disk including a universal serial bus (USB) memory, a storage medium which is connected to a host, and a web server through a network.

The storage unit 160 stores a density pattern of a scan data generation area for an external area provided by the UI unit 140 or the communication interface unit 150.

In this case, the detection unit 120 determines the position of the scan data generation area to be output by the output unit 130 by sensing a point corresponding to the density pattern from among the scan area of the main-scanned page.

More specifically, the detection unit 120 sequentially compares whether there is an area corresponding to the density pattern from one side of the scan area of the main-scanned page.

A page to be scanned is each page of a document for bookbinding, and a page to be free-scanned to provide a scan data generation area is a first page of the document for bookbinding.

In this case, if a scan data generation area is set only for one of a left page and a right page, the detection unit 120 mirrors the shape of the density pattern for the other page and determines if the main-scanned area of the other page corresponds to the mirrored density pattern from one side of the scanned area.

In addition, the detection unit 120 may reduce a scanned image of a page to be scanned and detect a relative position of a scan data generation area on the reduced image. In this case, a main-scanned image may be reduced in the same resolution as the resolution used for the preview. Accordingly, memory space may be saved and the operating speed can be improved.

In an exemplary embodiment of the present general inventive concept, the UI unit 140 displays an image free-scanned by the image reading unit 110, and receives a scan data generation area to be output by the output unit 130 from the user. For example, the user can set a scan data generation area using a mouse or a touch device (in the case of a touch panel).

Alternatively, in another embodiment of the present general inventive concept, the communication interface unit 150 can transmit a free-scanned image to a host device (not shown) and can receive data regarding a scan data generation area set on the free-scanned image from the host device.

The control unit 170 controls the components of the image forming apparatus 100 according to diverse pre-stored programs. More specifically, the control unit 170 receives a scanning command through the UI unit 140 and controls the image reading unit 110 to scan a document.

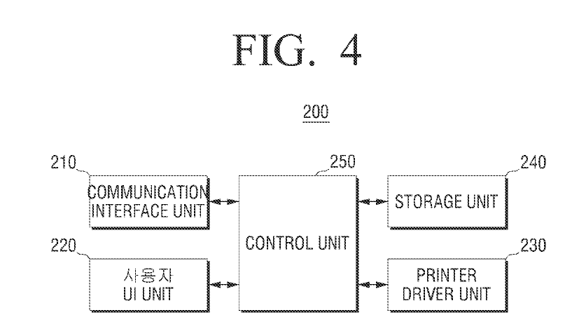

In this exemplary embodiment of the present general inventive concept, operations related to scanning a document for bookbinding are controlled by the components of the image forming apparatus 100, but this is merely an example. All the operations described above may be controlled by a printer driver (not shown) or an application (not shown) in a host device (not shown) which is connected to the image forming apparatus 100. Detailed description is given with reference to FIG. 4.

FIG. 4 is a schematic block diagram illustrating a configuration of a printing control terminal apparatus according to an exemplary embodiment of the present general inventive concept

The printing control terminal apparatus 200 in FIG. 4 supports a resource saving mode, and is connected to an image forming apparatus to print a document. The printing control terminal apparatus 200 may be implemented as a notebook computer, a personal digital assistant (PDA), portable multimedia player (PMP), and a mobile phone as well as a personal computer.

The printing control terminal apparatus 200 may include a communication interface unit 210, a UI unit 220, a printer driver unit 230, a storage unit 240, and a control unit 250.

The communication interface unit 210 is connected to at least one image forming apparatus so as to provide the image forming apparatus with a converted printing data for a printing job (converted document data and selected printing option information). More specifically, the communication interface unit 210 connects the printing control terminal apparatus 200 with the image forming apparatus, and may be implemented as a parallel port, a universal serial bus (USB) port, or a wireless module.

The communication interface unit 210 receives a free-scanned image of a page to be scanned from the image forming apparatus.

The UI unit 220 may include a plurality of function keys so that the user can set or select diverse functions supported by the printing control terminal apparatus 200. The UI unit 220 may be implemented as a touch pad capable of both input and output, or a mouse. The user selects document data to be printed by the image forming apparatus and selects a printing option to be applied to the selected document data through the UI unit 220.

In addition, the UI unit 220 displays diverse information provided by the printing control terminal apparatus 200. The UI unit 220 displays a screen to set a scan data generation area. More specifically, the UI unit 220 displays a free-scanned image received through the communication interface unit 210 on a preview screen, and receives a user command to set a scan data generation area.

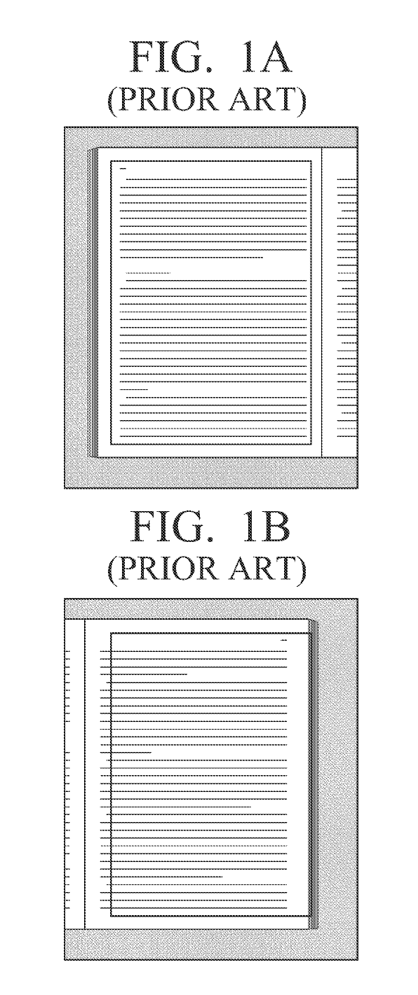

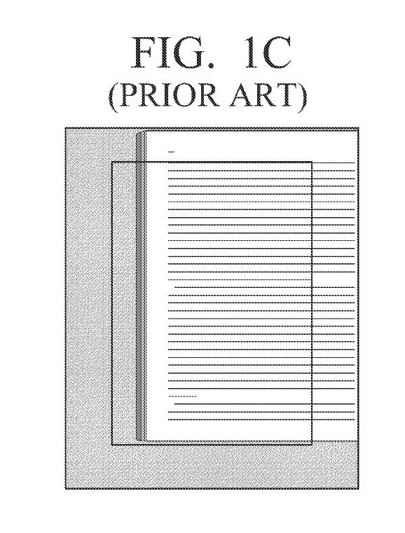

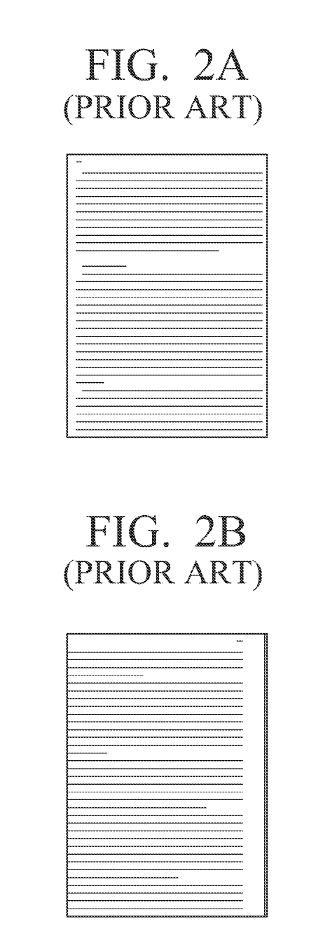

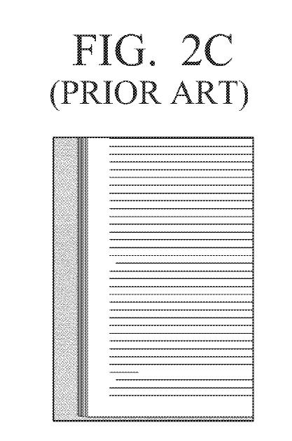

Since objects and display forms which are displayed on the UI unit 220 are the same as those which are displayed on the UI unit 140 of the image forming apparatus 100 shown in FIG. 1, a detailed description is omitted.

The printer driver unit 230 may include a plurality of drivers corresponding to a plurality of languages, and can thus perform printing jobs for a plurality of image forming apparatuses operating while using different languages. More specifically, when the user prints a document written using an application program, the printer driver unit 230 generates printing data using a printing language which can be recognized by an image forming apparatus to be used.

The storage unit 240 stores image forming apparatus information received from the communication interface unit 210. The storage unit 240 temporarily stores printing data generated by the printer driver unit 230 and pre-stores a scripter which stores a printing option and printing language supported by each image forming apparatus model.

In addition, the storage unit 240 stores a density pattern for an external area of a scan data generation area provided through the communication interface unit 210 or the user interface unit 220.

The control unit 250 controls the components of the printing control terminal apparatus 200 according to pre-stored diverse programs.

The control unit 250 controls components needed to perform a printing job according to a printing option selected by the image forming apparatus using the printer driver 230. More specifically, the control unit 250 sets a relative position of a scan data generation area according to a page of a document for bookbinding based on the preset scan data generation area for a page to be scanned. The page to be scanned which provides information regarding the preset scan data generation area may be a firstly scanned page of the document for bookbinding.

The control unit 250 receives a scanning command through the UI unit 220, and transmits a command to control the scan unit 120 of the image forming apparatus 100 to perform scanning to the image forming apparatus.

Those skilled in the art know well that the printing control terminal apparatus 200 can perform the operations of the components of the image forming apparatus 100 shown in FIG. 1 within a possible image forming job using the printer driver unit 230, so a detailed description thereof is omitted.

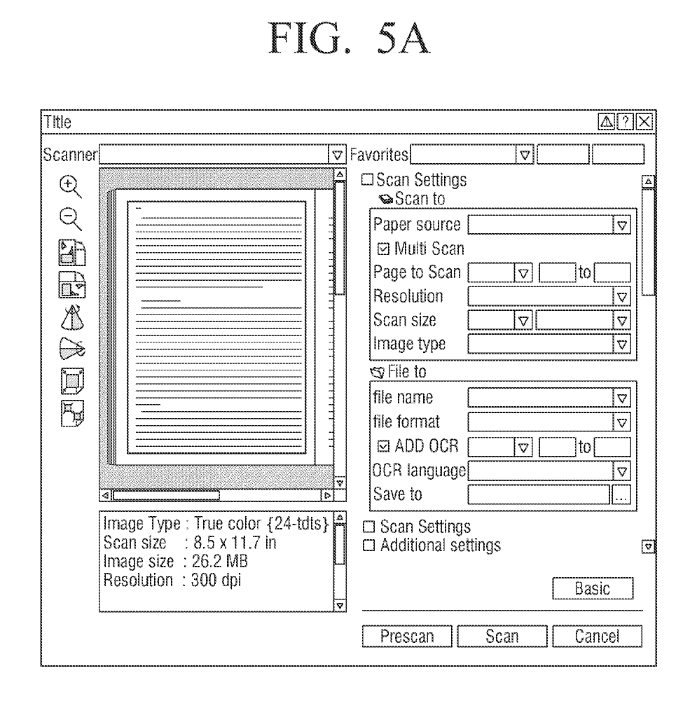

FIGS. 5A and 5B illustrate a method of setting an area according to an exemplary embodiment of the present general inventive concept.

FIG. 5A illustrates a menu screen to set a scan data generation area on a free-scanned image.

The user sets a scan data generation area on a free-scanned image using the menu screen shown in FIG. 5A. For example, in the case of a document for bookbinding, a first page to be scanned may be a page to be free-scanned.

FIG. 5B illustrates an example of a scan data generation area set on a free-scanned image.

As illustrated in FIG. 5B, a scan data generation area is set on a free-scanned image by the user, and areas expressed as reference numerals 1, 2, 3, 4, 1-2, 2-3, 3-4, and 4-1 are an external area of the scan data generation area.

In some cases, a scan data generation area may be set in a method of setting a relative position of a scan data generation area for a subsequently main-scanned page. For example, a scan data generation area can be automatically set on a free-scanned image according to a density pattern.

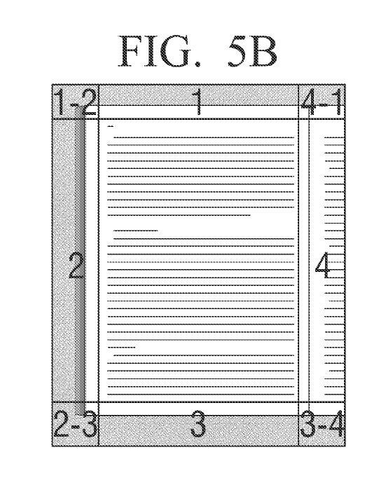

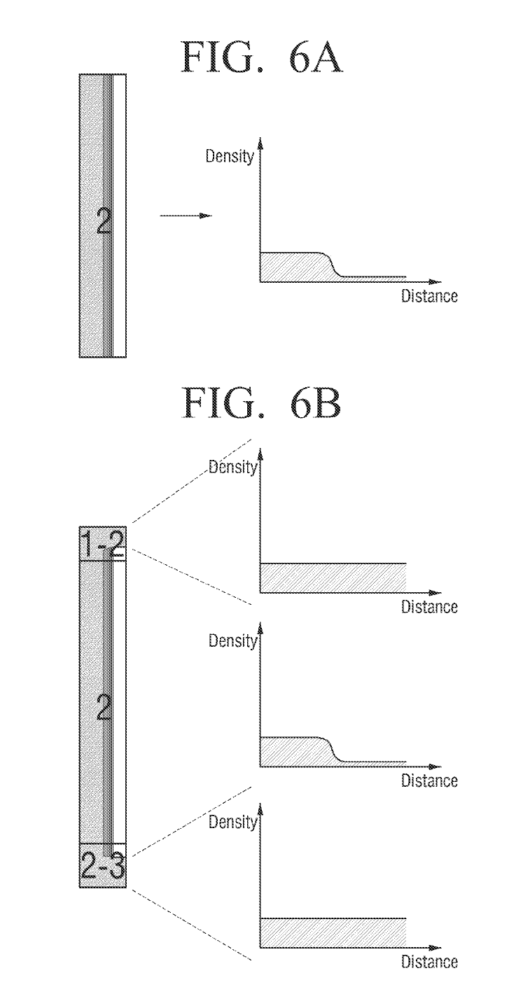

FIGS. 6A and 6B illustrate a method of detecting a relative position of a scan data generation area according to an exemplary embodiment of the present general inventive concept.

FIG. 6A illustrates a graph of a density pattern of area 2 set to be an external area of a scan data generation area shown in FIG. 5B.

A corresponding area is sensed by comparing the density pattern shown in FIG. 6A with a scan area of a subsequently main-scanned page.

More specifically, a relative position of a scan data generation area for a main-scanned data is determined by sequentially determining if the density pattern of area 2 corresponds to the density pattern of the subsequently main-scanned page from one side of the subsequently main-scanned page.

Following this method, if the same operation is performed for external area 1, left and upward borders for the relative position of the scan data generation area can be determined and right and downward borders can be set automatically (if the size of the scan data generation area is fixed).

Alternatively, in some cases, as illustrated in FIG. 6B, a corresponding area can be sensed by comparing the density patterns of external areas 1-2, 2, and 2-3 with the scan area of the subsequently main-scanned page. In this case, the left, upward, and downward borders of the scan data generation area can be determined at the same time.

If a scan data generation area is set on the left page from among the left and right pages as illustrated in FIG. 5B, a scan data generation area of the right page is set by mirroring the shape of the density pattern and determining if the mirrored density pattern corresponds to the right page from the right side of the main-scanned area in sequence.

That is, external area 2 is mirrored and it is determined if the mirrored density pattern corresponds to the right page from the right side of the main-scanned area in sequence.

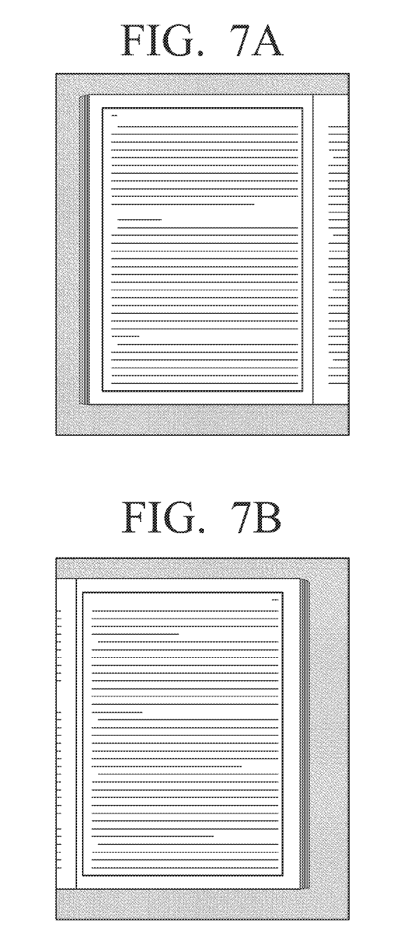

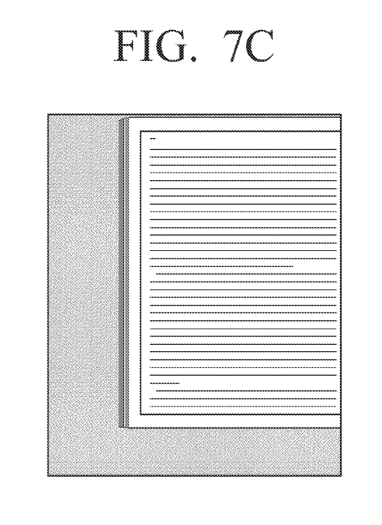

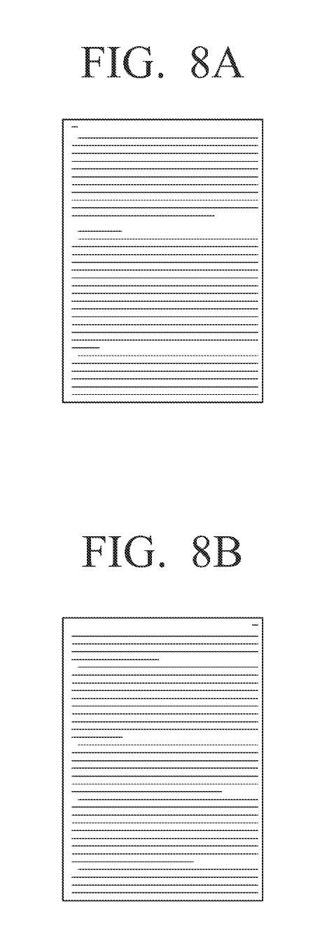

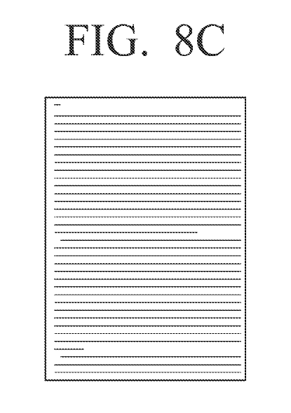

FIGS. 7A to 7C and FIGS. 8A to 8C illustrate the results obtained by a scanning method according to the present general inventive concept. For convenience of description, a document for bookbinding is described as an example, but it is possible to apply the scanning method according to the present general inventive concept to a document which is not for bookbinding.

If a scan data generation area is set on a first scan page of a document for bookbinding through free-scanning as illustrated in FIG. 7A, a scan data generation area can be set for subsequent pages as illustrated in FIGS. 7B and 7C, and precisely scanned data can be output as illustrated in FIGS. 8A to 8C.

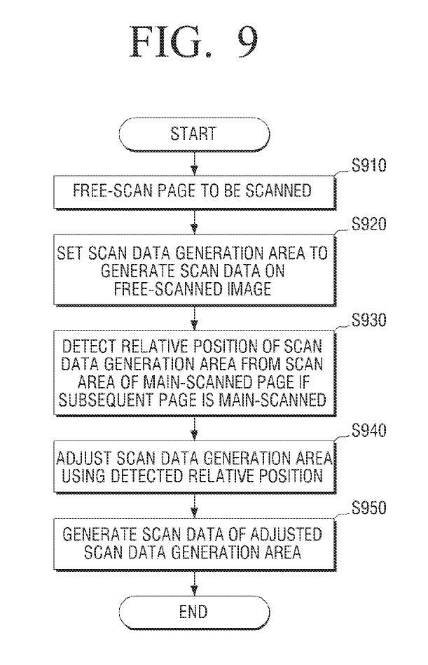

FIG. 9 is a flow chart illustrating a scanning method of an image forming apparatus according to an exemplary embodiment of the present general inventive concept.

According to the scanning method of the image forming apparatus according to the exemplary embodiment of FIG. 9, in operation S910 a page to be scanned is free-scanned, and in operation S920 a scan data generation area to generate scan data is set on the free-scanned image.

In this case, if the free-scanned image is displayed on the UI, the user can set the scan data generation area through the UI.

In operation S930, if a subsequent page is main-scanned, a relative position of the scan data generation area is detected from a scan area of the main-scanned page.

In this case, a density pattern for an external area of the scan data generation area is stored and a position corresponding to the density pattern is sensed from the scan area of the subsequent page and the relative position of the scan data generation area is determined based on the sensed position.

When a position corresponding to the density pattern is sensed, it is determined whether the density pattern corresponds to the main-scanned area from one side of the main-scanned area in sequence.

In operation S940, the scan data generation area is adjusted using the relative position detected in operation S930.

In operation S950, scan data of the scan data generation area adjusted in operation S940 are generated.

A page to be scanned may be each page of the document for bookbinding. If the scan data generation area is set on one of the left and right pages of the document for bookbinding, sensing a position corresponding to the density pattern in operation S930 includes mirroring the shape of the density pattern, and it is determined whether the mirrored density pattern corresponds to the scan area from the other side of the scan area in sequence.

In detecting the relative position of the scan data generation area in operation S930, a scanned image of a page to be scanned may be reduced and the relative position of the scan data generation area may be detected on the reduced image.

In a scanning method of an image forming apparatus according to another embodiment of the present general inventive concept, if a scan data generation area is set to generate scan data and main scanning is performed, an area corresponding to the scan data generation area is detected based on change of a density pattern of main-scanned data and the scan data generation area is adjusted to become the detected area.

Accordingly, scan data for the adjusted scan data generation area can be generated on the main-scanned data.

In a scanning method of an image forming apparatus according to yet another embodiment of the present general inventive concept, if a scan data generation area is set to generate scan data and main scanning is performed for a document, it can be determined if an image of the main-scanned document gets out of the scan data generation area using change of the density pattern.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

In addition, if the image of the main-scanned document gets out of the scan data generation area, the scan data generation area is adjusted to include the image of the main-scanned document.

Accordingly, scan data for the adjusted scan data generation area are generated.

Therefore, a document for bookbinding can be precisely scanned or copied with a specific size.

In addition, a plurality of pages can be scanned more rapidly than when the user sets a scan data generation area for each page.

Furthermore, using a reduced image, memory can be saved and the operating speed can be improved.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A scanning method of an image forming apparatus, the scanning method comprising:
free-scanning a page to be scanned;
setting a scan data generation area to generate scan data on the free-scanned image;
when a subsequent page is main-scanned, detecting a relative position of the scan data generation area from a scanned area of the main-scanned page;
adjusting the scan data generation area using the detected relative position; and
generating scan data for the adjusted scan data generation area.

2. The scanning method according to claim 1, wherein the setting of the scan data generation area comprises:
displaying the free-scanned image on a user interface (UI); and
receiving settings of the scan data generation area according to a user's selection using the UI.

3. The scanning method according to claim 1, wherein the detecting of the relative position comprises:
storing a density pattern for an external area of the scan data generation area;
sensing a position corresponding to the density pattern from among the scanned area of the main-scanned page; and
determining the relative position of the scan data generation area based on the sensed position.

4. The scanning method according to claim 3, wherein in the sensing of the position corresponding to the density pattern, it is determined if the density pattern corresponds to the main-scanned area from one side of the main-scanned area in sequence.

5. The scanning method according to claim 4, wherein the page to be scanned is each page of a document for bookbinding, and if the scan data generation area is set on one of a left page and a right page of the document for bookbinding, in the sensing of the position corresponding to the density pattern, a shape of the density pattern is mirrored for the other page and it is determined if the main-scanned area of the other page corresponds to the mirrored density pattern from one side of the main-scanned area.

6. The scanning method according to claim 1, wherein in the detecting of the relative position of the scan data generation area, a main-scanned image for the page to be scanned is reduced and the relative position of the scan data generation area is detected on the reduced image.

7. A scanning method of an image forming apparatus, the scanning method comprising:
setting a scan data generation area to generate scan data;
if data are scanned, detecting an area corresponding to the scan data generation area based on change of a density pattern of the scanned data;
adjusting the scan data generation area to become the detected area; and
generating scan data for the adjusted scan data generation area on the scanned data.

8. A scanning method of an image forming apparatus, the scanning method comprising:
setting a scan data generation area to generate scan data;
if a document is scanned, determining if an image of the scanned document gets out of the scan data generation area using change of a density pattern;
if the image of the scanned document gets out of the scan data generation area, adjusting the scan data generation area to include the image of the scanned document; and
generating scan data for the adjusted scan data generation area.

9. An image forming apparatus, comprising:
an image reading unit to free-scan a page to be scanned;
a detection unit to set a scan data generation area to generate scan data on the free-scanned image, and if the image reading unit main-scans a subsequent page, to detect a relative position of the scan data generation area from a scanned area of the main-scanned page; and
a control unit to adjust the scan data generation area using the detected relative position and generate scan data for the adjusted scan data generation area.

10. The image forming apparatus according to claim 9, further comprising:
a user interface (UI) unit to display the free-scanned image and receive settings of the scan data generation area according to a user's selection.

11. The image forming apparatus according to claim 9, further comprising:
a communication interface unit to transmit the free-scanned image to a host device and receive data regarding the scan data generation area set on the free-scanned image from the host device.

12. The image forming apparatus according to claim 9, further comprising:
a storage unit to store a density pattern for an external area of the scan data generation area,
wherein the detection unit senses a position corresponding to the density pattern from among the scanned area of the main-scanned page and determines the relative position of the scan data generation area based on the sensed position.

13. The image forming apparatus according to claim 9, wherein the detection unit determines if the density pattern corresponds to the main-scanned area from one side of the main-scanned area in sequence.

14. The image forming apparatus according to claim 13, wherein the page to be scanned is each page of a document for bookbinding, and if the scan data generation area is set on one of a left page and a right page of the document for bookbinding, the detection unit mirrors a shape of the density pattern for the other page and determines if the main-scanned area of the other page corresponds to the mirrored density pattern from one side of the main-scanned area.

15. The image forming apparatus according to claim 9, wherein the detection unit reduces a main-scanned image for the page to be scanned and detects the relative position of the scan data generation area on the reduced image.

16. A scanning method of an image forming apparatus, comprising:
scanning a page;
determining boundaries of data of the scanned page to create a data generation area;
scanning a subsequent page and determining boundaries of the scanned subsequent page;
adjusting the created data generation area by comparing the boundaries of the scanned subsequent page; and
generating scan data for the adjusted data generation area.

17. The scanning method of according to claim 16, wherein the creating a data generation area comprises:
displaying the scanned page on a user interface (UI); and
receiving settings of the data generation area to be created according to a user's selection using the UI.

18. The scanning method according to claim 16, wherein the determining boundaries of the scanned subsequent page comprises:
storing a density pattern for an external area of the data generation area;
sensing a position corresponding to the density pattern from among the scanned area of the subsequent scanned page; and
determining the boundaries of the scanned subsequent page based on the sensed position.
